(19) United States
(12) Patent Application Publication
(10) Pub. No.: US 2002/0113705 A1
(43) Pub. Date: Aug. 22, 2002

(54) Device and method for preventing the theft or loss of a personal item

(76) Inventor: Terence Wallace, Bronx, NY (US)

Correspondence Address: KENYON & KENYON, ONE BROADWAY, NEW YORK, NY, 10004, US

(21) Appl. No.: 09/932,065

(22) Filed: Aug. 17, 2001

Related U.S. Application Data
(60) Provisional application No. 60/226,266, filed on Aug. 17, 2000.

(51) Int. Cl. G08B 13/14

(52) U.S. Cl. 340/568.7; 340/568.1

(57) ABSTRACT

The present invention relates to a portable security device which attaches to small personal items such as a handbag, wallet, electronic device, laptop computer or musical instrument. The present invention provides a device and method that enables a user to provide a measure of security to a valuable possession. This portable security device, in one exemplary embodiment, consists of a single device that may be attached to the personal item it is monitoring, however the security device may be used in conjunction with a remote. The security device alerts a user if the user should lose possession of the personal item either accidently or due to theft. The security device may also detect any tampering that may have taken place if the user should leave an item unattended.

CROSS-REFERENCE TO RELATED APPLICATIONS

This application claims priority to U.S. Provisional Patent Application Serial No. 60/226,266, filed Aug. 17, 2000, pursuant to 35 U.S.C. § 119(e), the disclosure of which is incorporated by reference in its entirety herein.

### FIELD OF THE INVENTION

The present invention relates to a portable security device which attaches to small personal items such as a handbag, wallet, electronic device, laptop computer or musical instrument.

### BACKGROUND OF THE INVENTION

Anti-theft security devices are generally available in many forms and provide users with various levels of protection. Most security devices are installed in homes, motor vehicles, offices and storage facilities. Security devices range in various levels of complexity from complex systems which include central monitoring services to local audible alarms. Motor vehicle anti-theft systems may also include tracking systems in order to locate a vehicle's location. Commonly these anti-theft systems are used only on real property and large personal property. Most of the anti-theft systems available are not designed to be used in conjunction with smaller personal property, e.g., portable radios, purses, wallets, laptop computers, and personal digital assistants (PDA). Furthermore, in many instances these systems are permanently fixed to the building or vehicle.

Many individuals frequently transport small personal property while traveling or commuting to and from work. Occasionally personal items are left unattended or unintentionally misplaced by the user. Individuals who transport personal property would find it advantageous to have a universal portable security device. It would also be advantageous if the portable security device was easily attachable to various items and provided the user with instantaneous alerts . The user of the portable security device would also benefit if the device provided the user with options in regard to methods of signaling the user of a potential theft or simply reminding the user of location of the personal property.

The present invention seeks to provide the user with a universal portable security device.

### SUMMARY OF THE INVENTION

The present invention, hereinafter, “Personal Alert (PA),” is a device that permits a user to provide a measure of security to a valuable possession. In one exemplary embodiment, the PA system consists of a single device that may be attached to the object it is monitoring. In this embodiment, the PA will sound an alarm whenever a motion sensor contained inside PA detects any potential theft. At this threshold level, the device will sound an audible alarm loud enough to both attract the attention of the user (if in close proximity) and/or discourage the theft of the object to which it is attached. The alarm will continue to sound for a predetermined period of time or until it is silenced by the user. The user may arm the PA by selecting an alarm function and then inputting a valid user ID. An alphanumeric liquid crystal display (LCD) may be used to provide an indication of the alarm function(s) selected.

In another exemplary embodiment, the PA in conjunction with a remote may be used as a tamper indicator. Under this embodiment, the PA or the remote may be programmed to sound an audible alarm (audible mode) or to flash a yellow light emitting diode (LED) (silent alarm mode). The silent alarm mode is used to notify the user that the PA or object to which it is attached had been disturbed. In both silent or audible mode, if the object is disturbed the yellow light will continue flashing until the user resets it.

In another exemplary embodiment, the PA is also capable of sensing when the distance between the object to which it is attached and the user has increased beyond a preset distance. In this embodiment, the PA system consists of two devices. The PA attached to the object and a remote attached to or in the possession of the user. The user sets the predetermined distance by placing the two devices at the “trigger” distance and then pressing the “set” button on the remote. If the object is moved beyond this distance or if the user moves beyond this distance then an alarm is registered at the PA or at the remote or both as determined by the function selected by the user. The indication may be either an audible alarm or a silent vibration as used in a paging device. The trigger distance may be changed at anytime by pressing the set button on the remote. When the trigger distance must be adjusted in response to changing conditions or situations, it can be easy done by the user from the remote without any need to reprogram the PA, where the PA is acting as the transmitter and remote is the receiver in this case.

In another exemplary embodiment, the PA system functions as a “homing” device. If the user should become separated from the object being secured, this homing function will enable the user to locate the object. In this mode, the “homing” button on the remote is held in while the user listens for the audible signal emanating from the PA. The homing function does not require arming and is readily available to the user. The PA emits a pulsating sound that increases in frequency as the user comes closer to the object. Additionally, the PA will flash a red LED whenever battery power becomes low. As an added convenience, the PA also provides standard clock type functionality.

### BRIEF DESCRIPTION OF THE DRAWINGS

FIG. 1 shows a frontal view of an exemplary embodiment of the present invention.

FIG. 2 shows an internal view of the present invention.

FIG. 3a shows a rear view of the present invention.

FIG. 3b shows another rear view of the present invention.

FIG. 4a shows an exemplary use for the present invention.

FIG. 4b shows the personal alert used in conjunction with an article of luggage.

FIG. 5 shows another exemplary use for the present invention.

FIG. 6 shows yet another exemplary use for the present invention.

FIG. 7a shows an exemplary attachment device.

FIG. 7b shows the attachment device attached to a wallet.

FIG. 8 shows an exemplary method according to the present invention.

### DETAILED DESCRIPTION

The PA alerts a user if the user should lose possession of a personal item either accidently or due to theft. The PA may also be used to detect any tampering that may have taken place if the user should leave an item unattended. The PA is relatively small and provides flexible attachment options. The present invention provides a vast amount of versatility and features as set forth in the description below.

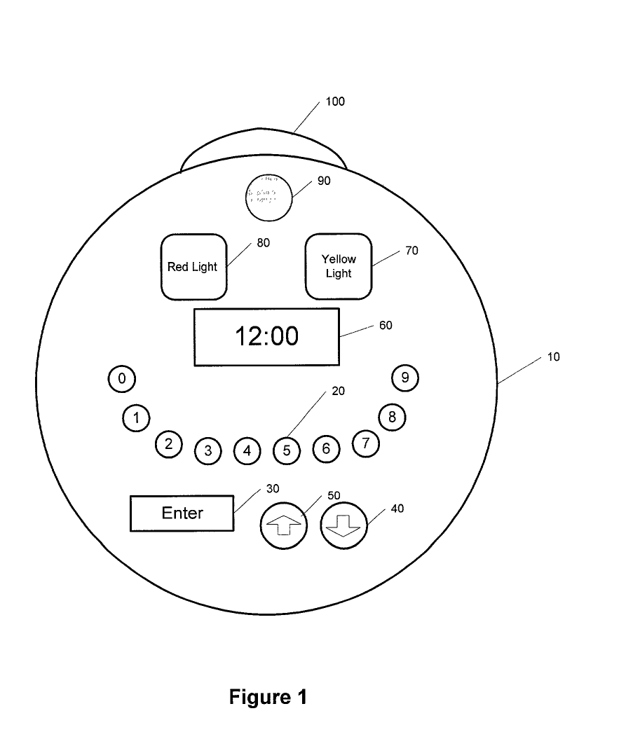

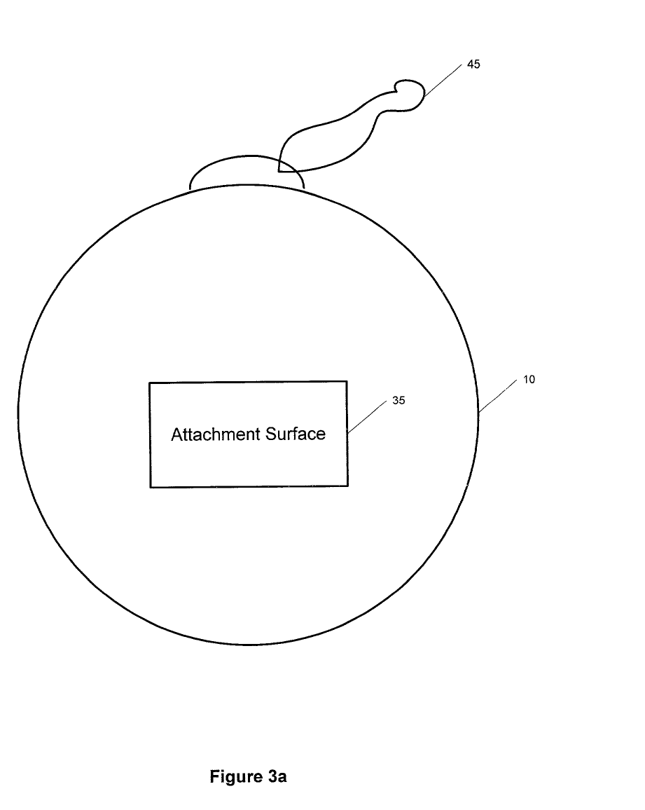

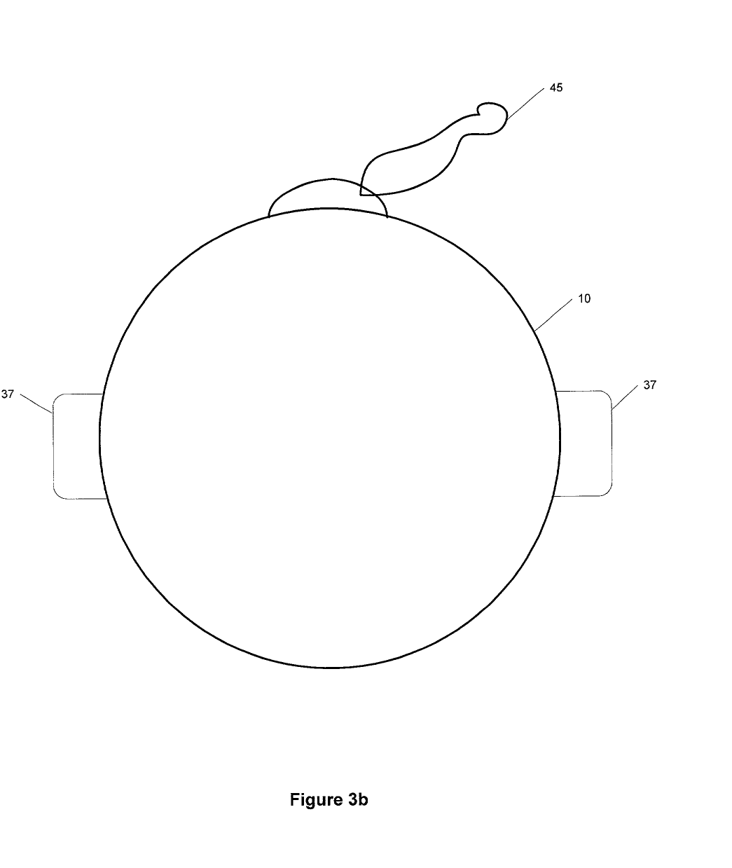

FIG. 1 shows a frontal view of an exemplary embodiment of the present invention. The personal alert 10 includes several components which enable its functionality. A numerical keypad 20 enables a user to input numerical sequences (codes) which activate various functions associated with the personal alert 10, e.g. set alarm, mode of operation, clock and alarm parameters. An enter pad 30 allows the user to input a code which activates the function associated with the code. Input pads 40, 50 provides the user with further input functions related to time display and alarm settings. A time display 60 displays the time and enables the personal alert 10 to function as a watch in conjunction to the alarm features. The time display 60 may also function as an alarm reset button and enable the user to set alarm functions associated with the personal alert 10. Alert lights 70, 80 each activate based upon functions input by the user, e.g., audible alarm set, signal mode set. In one exemplary embodiment, the alert lights 70, 80 may be light emitting diodes (LED). A speaker/set button 90 emits an audible alarm based upon settings activated by the user. An attachment loop 100 allows for the insertion a hand strap 45, shown in FIGS. 3a and 3b, for transporting the personal alert 10 or may be used as a key ring.

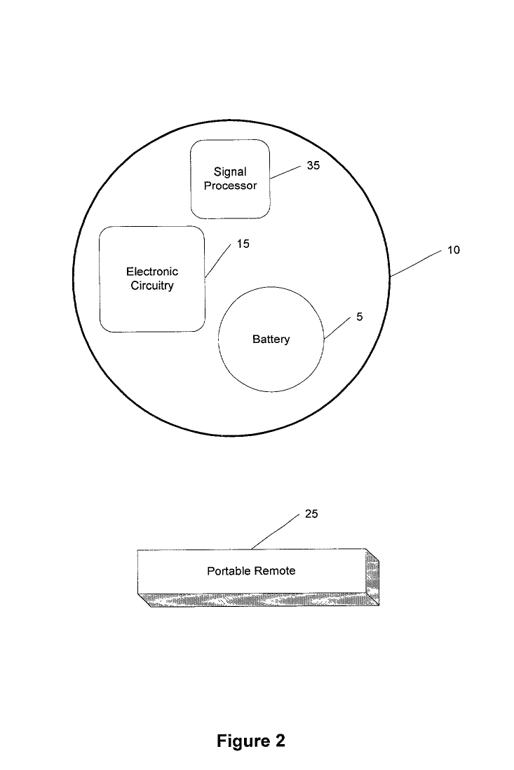

FIG. 2 shows an internal view of the personal alert 10 in the form of a functional block diagram. The internal portion of the personal alert 10 comprises a battery 5, an electronic circuitry 15 and a signal processor 35. The battery 5 rests within a detachable housing which inserts through an opening (not shown) on the perimeter surface of the personal alert 10. The battery 5 may be either nickel-cadmium or lithium type. The electronic circuitry 15 includes a microprocessor and a memory arrangement. The memory arrangement, e.g., RAM, ROM, may store data and software applications which enable the functions associated with the personal alert 10. The signal processor 35 transmits or receives wireless analog or digital signals and is used in conjunction with a portable remote 25, e.g., transponder. The electronic circuitry 15 also provides for the transmission of power from the battery 5 to components of the electronic circuitry 15, the signal processor 35, and the external components as shown in FIG. 1, e.g., time display 60, alert lights 70, 80, speaker/set button 90, etc. The portable remote 25 as shown in FIG. 2 may be used with the personal alert 10 in one exemplary embodiment of the present invention. The portable remote 25 may be inserted into a small portable item such as a ink pen, clip on attachment, tie pin, broach, hair pin, etc. The portable remote 25 transmits and/or receives signals from the signal processor 35.

FIG. 3a shows a rear view of the personal alert 10. The rear view shows an attachment surface 35 such as velcro or an adhesive strip. The attachment surface 35 enables the user to attach the personal alert 10 to an object that the user wishes to secure. FIG. 3b shows another rear view of the personal alert 10. As shown in FIG. 3b, attachment extensions 37 extend from the perimeter of the personal alert 10 that enable the personal alert 10 to be attached to an attachment device or directly to the object itself.

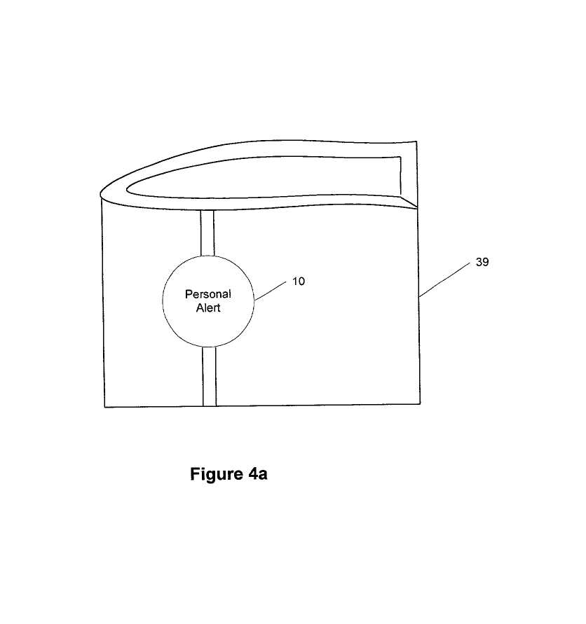

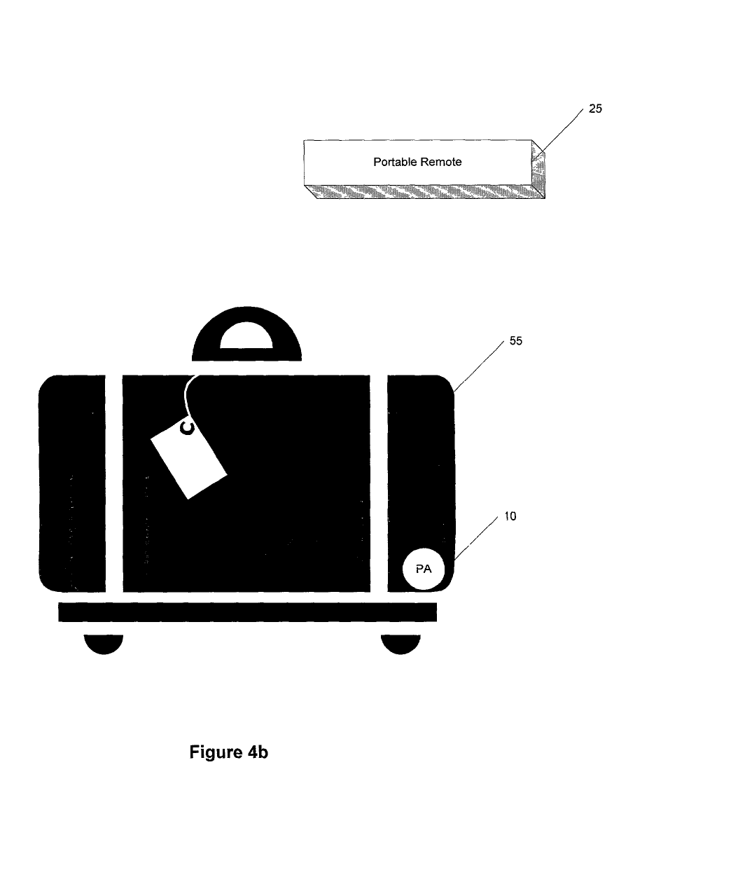

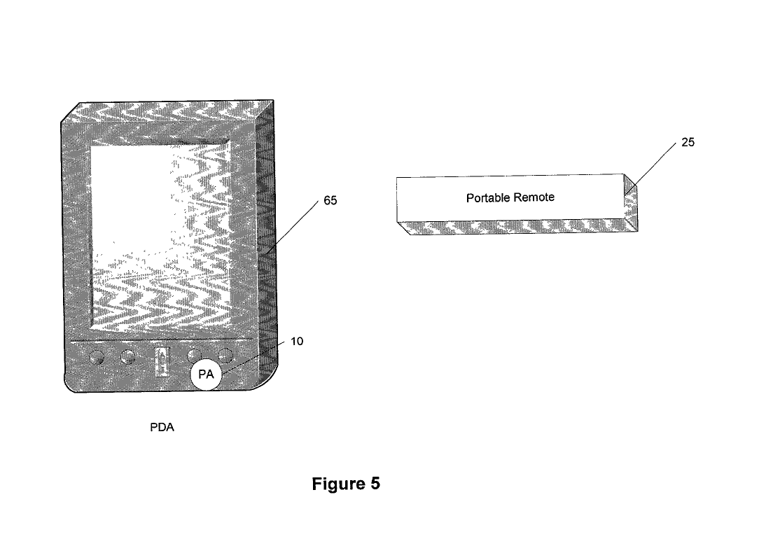

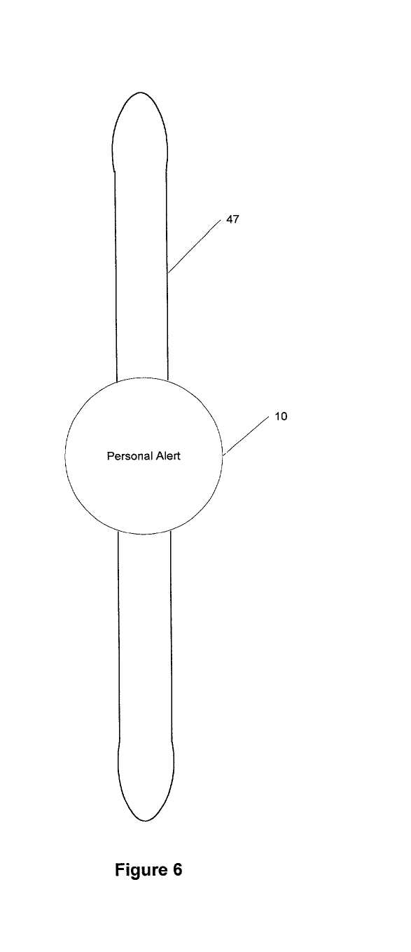

FIG. 4a shows an exemplary use for the personal alert 10, in FIG. 4a the personal alert 10 is used on a conventional wallet 39 with an attachment device. As depicted in FIG. 4a, the personal alert 10 is securely attached to the wallet with the attachment device, but however is not permanently affixed to the wallet. Other attachment devices may be used which enable the user to permanently affix the personal alert 10 to the wallet 59. FIG. 4b shows another exemplary use for the personal alert 10. As shown in FIG. 4b, the personal alert 10 may be used in conjunction with an article of luggage 55, e.g., briefcase, luggage bag, purse, or handbag. FIG. 5 shows another exemplary use for the personal alert 10. As shown in FIG. 5, the personal alert 10 may be used with a small electronic device such as a personal digital assistant 65. FIG. 6 shows yet another exemplary use for the personal alert 10 where the personal alert 10 is used with a wrist strap 47. As shown in FIG. 6, the personal alert 10 may be attached to an infant's wrist and used in conjunction with the portable remote 25 as shown in FIG. 2. Also, the embodiment shown in FIG. 6 may be used with a pet, e.g., a dog or cat collar.

The personal alert 10 provides a portable electronic alarm device to prevent theft of personal items such as musical instruments, wallets, briefcases, keys, computers, jewelry boxes, pocket organizers, personal diaries, handbags, pocket and palm PC's, lap top computers, camcorders, cameras, portable CD players and portable phones. The personal alert 10 may be used independently or used in conjunction with the portable remote 25. If the personal alert 10 is used independently, the alarm may be triggered by use of a motion sensor. In one exemplary embodiment, the personal alert 10 may be attached to a wallet where the wallet would be carried by the user. If the wallet is removed, the motion sensor detects a motion change, based upon the preset parameters, and then triggers the alarm in the personal alert 10. When the personal alert 10 is used with the portable remote 25, the signal processor 35 determines a received signal strength (RSS) between the portable remote 25 and signal processor 35. The signal processor 35 triggers the alarm once it detects a predetermined loss in RSS. The RSS would inversely change in relation to the distance between the portable remote 25 and the personal alert 10, e.g., RSS decreases as the distance increases. The personal alert 10 could therefore alert a user if a personal item is moved a predetermined distance away from the portable remote 25 where the personal alert 10 is attached to the personal item.

Securing items at very close proximity to the user may require the use of a “disable” switch. For example, the PA is attached to a person's wallet or purse and the remote is also located on the person. A “trigger” distance is set, for example, at a distance of two feet. If the person removes his own wallet he may trigger the alarm unless there is a mechanism by which he can disable the alarm before it occurs. The person must reach down into his pocket and slide the disable switch on the PA (the PA sends an message to the remote disabling the security system) or the disable switch on the remote into the disarmed position (the remote then ignores any drop in received signal strength). Upon returning the PA to his pocket the user would slide the disable switch back into the armed position.

In one exemplary embodiment, the personal alert 10 may have a stainless steel shell which is waterproof, shockproof and heat resistant. The alarm in the personal alert 10 may alert a user either audibly or visually. The alarm, when triggered, may emit a loud piercing sound from the speaker 90 or the alert lights 70, 80 may flash based upon the predetermined user settings. Therefore, the personal alert 10 helps to detect theft and prevent loss of any personal item that the user may desire to protect. Also as alternative to the audible alarm, the personal alert 10 may be set to vibrate when used with the portable remote 25. A “panic” button on the remote is also available as a measure of personal protection to the user. This function provides a means of sounding an alarm to deter unwanted confrontations. The user simply holds in the panic button until the audible alarm begins to sound. The alarm sounds for a preset period of time and may not be silenced even if dislodged from the user's hand.

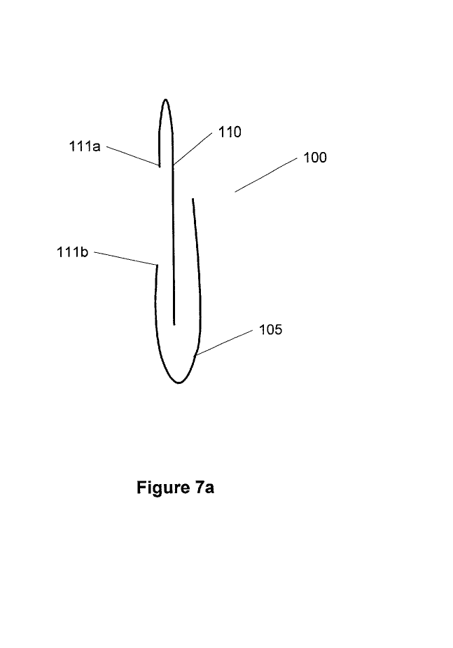

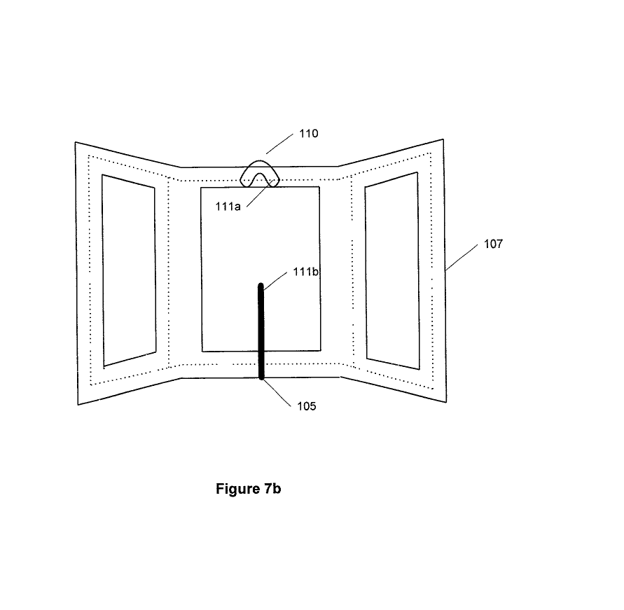

FIG. 7a shows an exemplary embodiment of an attachment device 100. The attachment device 100 includes a lower portion 105 and an upper portion 110. When the attachment device 100 is used with the personal alert 10, lower portion 105 and upper portion 110 are attached to an object where the personal alert 10 is placed between attachment points 111a and 111b as shown in FIG. 7a. The attachment device 100 slidingly attaches to an object where the object is placed between lower portion 105 and upper portion 110. The personal alert 10 may use the attachment extensions 37 in conjunction with attachment device 100. The attachment points 111a and 111b, may be modified in order to accommodate the personal alert 10 without using the attachment extensions 37.

FIG. 7b shows the attachment device being used on a wallet 107. The lower and upper portions 105, 110 attach to the wallet 107 as shown, and allow for the insertion of the personal alert 10 in between connection points 111a and 111b

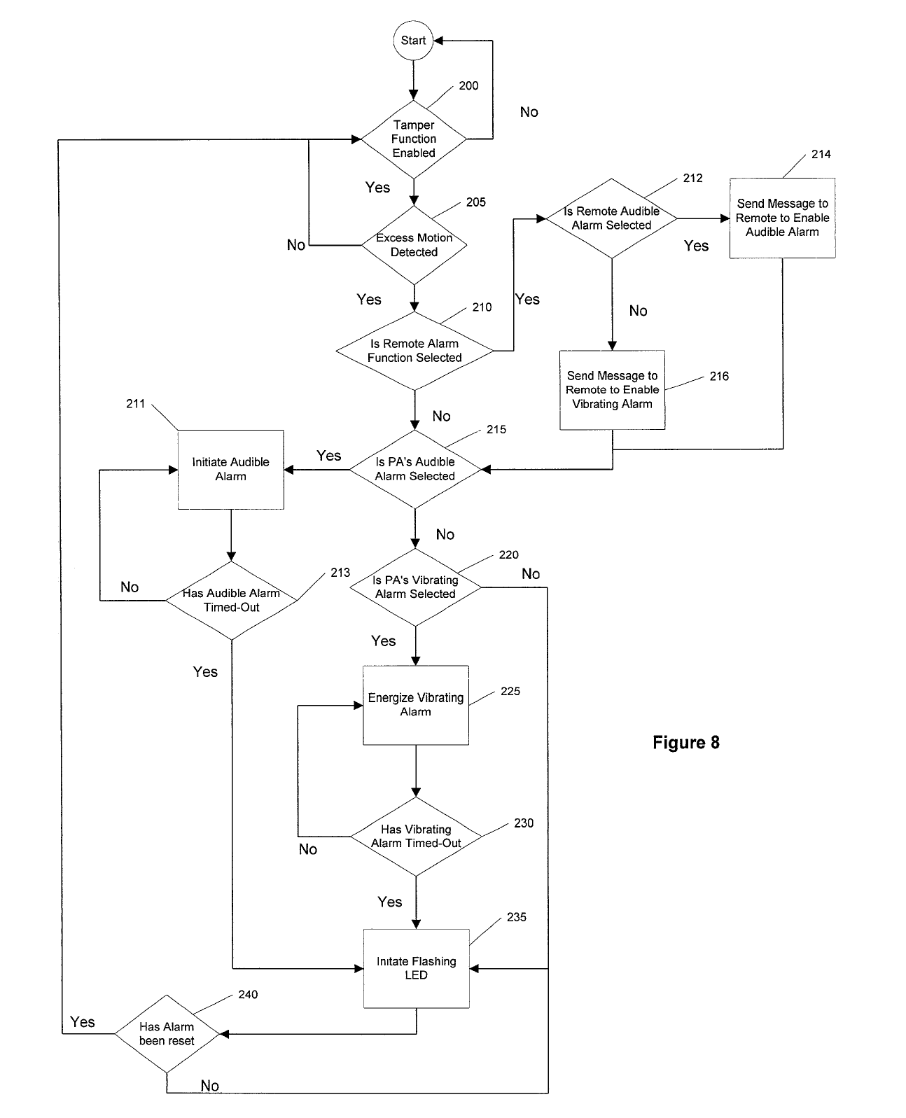

FIG. 8 shows an exemplary embodiment of a method according to the present invention. The method may be enabled using software residing in the memory arrangement residing in the electronic circuitry 15. Initially, the software determines whether the tamper function has been selected by the user, step 200. If the tamper function is set, the software continuously checks for excess motion, step 205. Once excess motion is detected, the software determines which alarm mode has been selected. If the remote alarm is selected, step 210, the software determines if the remote audible alarm has been selected, step 212. If selected, the remote audible alarm is initiated, step 214, if not the vibration alarm is initiated, step 216. If the software finds that the PA's audible alarm has been selected, step 215, then the PA's audible alarm is initiated for a pre-set time period, steps 211 and 213. If the PA's vibrating alarm has been selected, step 220, then the vibrating alarm is initiated for a pre-set time period, steps 220, 225 and 230. If neither the audible or vibrating alarms have been selected by the user, the software initiates the flashing LED until the alarm is reset by the user, step 240. The above method sets forth the PA function when the PA is set in the tamper mode as described above. Similar methods are implemented through the software in regard to the other modes of operation described above.

Several embodiments of the present invention are specifically illustrated and/or described herein. However, it will be appreciated that modifications and variations of the present invention are covered by the above teachings and within the purview of the appended claims without departing from the spirit and intended scope of the present invention.

What is claimed is:

1. A security device for securing an object comprising:
a housing wherein the housing includes a signal processor, a circuit arrangement and a energy source;
an attachment device where the attachment device attaches the housing to the object;
a remote where the remote transmits and receives signals to and from the signal processor, wherein the signals include at least one of digital and analog signals;
an input arrangement wherein the input arrangement enables a user to input commands to the circuit arrangement and signal processor, where the commands set at least one operation mode for the security device; and
an output arrangement where the output arrangement produces an output based on the input commands.

2. A method of securing an object using a security device comprising the steps of:
setting operational parameters of the security device;
determining an operation mode of the security device;
detecting a triggering signal based on the operational parameters;
selecting an output response based on the operational parameters; and
executing the output response for at least one of a predetermined period of time and upon receipt of stop output command from the user.
